(19) United States
(12) Patent Application Publication
(10) Pub. No.: US 2026/0349778 A1
(43) Pub. Date: Nov. 5, 2026

(54) SYSTEM-ON-CHIP AND METHOD FOR MULTI-DOMAIN AUDIO MANAGEMENT

(71) Applicant: MediaTek Singapore Pte. Ltd., Singapore (SG)

(72) Inventor: Fan YANG, Wuhan (CN)

(21) Appl. No.: 19/411,627

(22) Filed: Dec. 8, 2025

(30) Foreign Application Priority Data
Apr. 30, 2025 (CN) 202510571519.3

(51) Int. Cl. G06F 9/455; G06F 3/16

(52) U.S. Cl. CPC G06F 9/45558; G06F 3/165; G06F 2009/45579

(57) ABSTRACT

A system-on-chip (SoC) includes a system processor and an audio processor. The system processor executes a hypervisor to virtualize multiple virtual machines (VMs). The VMs output audio data and control data from multiple vehicle-mount devices. One of the VMs is a host virtual machine (VM), and the other VMs are guest VMs. The audio processor is electrically connected to the system processor. The audio processor receives the audio data and the control data from the system processor, establishes multiple tasks based on the audio data and the control data from the VMs, performs mixing and audio processing on the audio data task-by-task to generate processed audio data, and outputs the processed audio data to audio hardware.

### CROSS REFERENCE TO RELATED APPLICATIONS

This Application claims priority of China Patent Application No. 202510571519.3, filed on Apr. 30, 2025, the entirety of which are incorporated by reference herein.

### BACKGROUND OF THE INVENTION

### Field of the Invention

The present invention relates to an electronic device, and, in particular, to a system-on-chip (SoC) and a method for multi-domain audio management.

### Description of the Related Art

At present, vehicle-mounted infotainment systems are developing rapidly, and they are extremely complex in terms of multi-domain chip management. For example, each field (such as the main driver, co-driver, T-Box, and dashboard) requires its own main control chip. To realize the multi-domain function of a single chip, virtualization technology is inevitably involved.

There are currently two types of smart cockpit systems: single-master SoC and multi-master SoC. The multi-domain audio processing of both mainly relies on external audio digital signal processor (ADSP). Multi-master SoC relies on the external ADSP to have sufficient audio I/O and communication interface capabilities to meet the increasingly large and diverse audio scene requirements. Single master SoC is similar, but it will additionally require the master SoC itself to have sufficient audio I/O and communication interface capabilities.

On the other hand, the audio application scenarios of each domain actually overlap, such as media sounds and key sounds. If multi-domain audio processing can be completed within a single master SoC, the design complexity of the entire system can be greatly reduced.

### BRIEF SUMMARY OF THE INVENTION

An embodiment of the present invention provides a system-on-chip (SoC). The SoC includes a system processor and an audio processor. The system processor executes a hypervisor to virtualize multiple virtual machines (VMs). The VMs output audio data and control data from multiple vehicle-mount devices. One of the VMs is a host virtual machine (VM), and the other VMs are guest VMs. The audio processor is electrically connected to the system processor. The audio processor receives the audio data and the control data from the system processor, establishes multiple tasks based on the audio data and the control data from the VMs, performs mixing and audio processing on the audio data task-by-task to generate processed audio data, and outputs the processed audio data to audio hardware.

According to the SoC described above, each VM includes a user space and a kernel space.

According to the SoC described above, the hypervisor virtualizes audio input/output (I/O) ports and digital signal processing (DSP) I/O ports in the kernel space of each guest VM.

According to the SoC described above, the hypervisor establishes an audio backend and an audio digital signal processing (ADSP) backend in the user space of the host VM.

According to the SoC described above, each guest VM sends the audio data to the host VM through the virtualized audio I/O port in the kernel space. The host VM receives the audio data from each guest VM through the audio backend in the user space.

According to the SoC described above, each guest VM sends the control data to the host VM through the virtualized DSP I/O port in the kernel space. The host VM receives the control data from each guest VM through the ADSP backend in the user space.

According to the SoC described above, the hypervisor establishes an audio driver and a DSP driver in the kernel space of the host VM. The audio driver drives the audio hardware based on the audio data from the vehicle-mount devices. The DSP driver sends the control data from the vehicle-mount devices to the audio processor to control the audio hardware.

According to the SoC described above, the VMs include a first VM, a second VM, and a third VM. The vehicle-mount devices include a first vehicle-mount device, a second vehicle-mount device, and a third vehicle-mount device. The first VM outputs audio data and control data from the first vehicle-mount device. The second VM outputs audio data and control data from the second vehicle-mount device. The third VM outputs audio data and control data from the third vehicle-mount device.

According to the SoC described above, the audio processor establishes a first task group based on the audio data and the control data from the first VM. The audio processor establishes a second task group based on the audio data and the control data from the second VM. The audio processor establishes a third task group based on the audio data and the control data from the third VM.

According to the SoC described above, the first task group includes tasks corresponding to the first VM. The second task group includes tasks corresponding to the second VM. The third task group includes tasks corresponding to the third VM.

According to the SoC described above, the audio data and the control data from vehicle-mount devices correspond to different audio application scenarios.

According to the SoC described above, the audio processor performs mixing and audio processing on the audio data based on application requirement in each of the tasks

An embodiment of the present invention also provides a method for multi-domain audio management. The method is applied to a system processor and an audio processor. The method includes the following steps. Multiple virtual machines (VMs) are virtualized. The VMs output audio data and control data from multiple vehicle-mount devices. One of the VMs is a host virtual machine (VM), and the other VMs are guest VMs. The audio data and the control data from the VMs are received. Multiple tasks are established based on the audio data and the control data from the VMs. Mixing and audio processing are performed on the audio data task-by-task to generate processed audio data. The processed audio data are output to audio hardware.

According to the method for multi-domain audio management described above, each VM includes a user space and a kernel space.

The method for multi-domain audio management further includes virtualizing audio input/output (I/O) ports and digital signal processing (DSP) I/O ports in the kernel space of each guest VM.

The method for multi-domain audio management further includes establishing an audio backend and an audio digital signal processing (ADSP) backend in the user space of the host VM.

The method for multi-domain audio management further includes the following steps. Each guest VM sends the audio data to the host VM through the virtualized audio I/O port in the kernel space. The host VM receives the audio data from each guest VM through the audio backend in the user space.

The method for multi-domain audio management further includes the following steps. Each guest VM sends the control data to the host VM through the virtualized audio I/O port in the kernel space. The host VM receives the control data from each guest VM through the ADSP backend in the user space.

The method for multi-domain audio management further includes establishing an audio driver and a DSP driver in the kernel space of the host VM. The audio driver drives the audio hardware based on the audio data from the vehicle-mount devices. The DSP driver sends the control data from the vehicle-mount devices to the audio processor to control the audio hardware.

According to the method for multi-domain audio management described above, the audio data and the control data from vehicle-mount devices correspond to different audio application scenarios.

According to the method for multi-domain audio management described above, the step of performing mixing and audio processing on the audio data task-by-task includes performing mixing and audio processing on the audio data based on application requirement in each of the tasks.

### BRIEF DESCRIPTION OF THE DRAWINGS

The present invention can be more fully understood by reading the subsequent detailed description and examples with references made to the accompanying drawings, wherein:

FIG. 1 shows a schematic diagram of a system-on-chip (SoC) 100 in accordance with some embodiments of the present invention;

FIG. 2 shows a detail schematic diagram of the SoC 100 in FIG. 1 in accordance with some embodiments of the present invention;

FIG. 3 shows a detail schematic diagram of the SoC 100 in FIG. 1 in accordance with some embodiments of the present invention; and

FIG. 4 show a flow chart of a method for multi-domain audio management in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to...”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

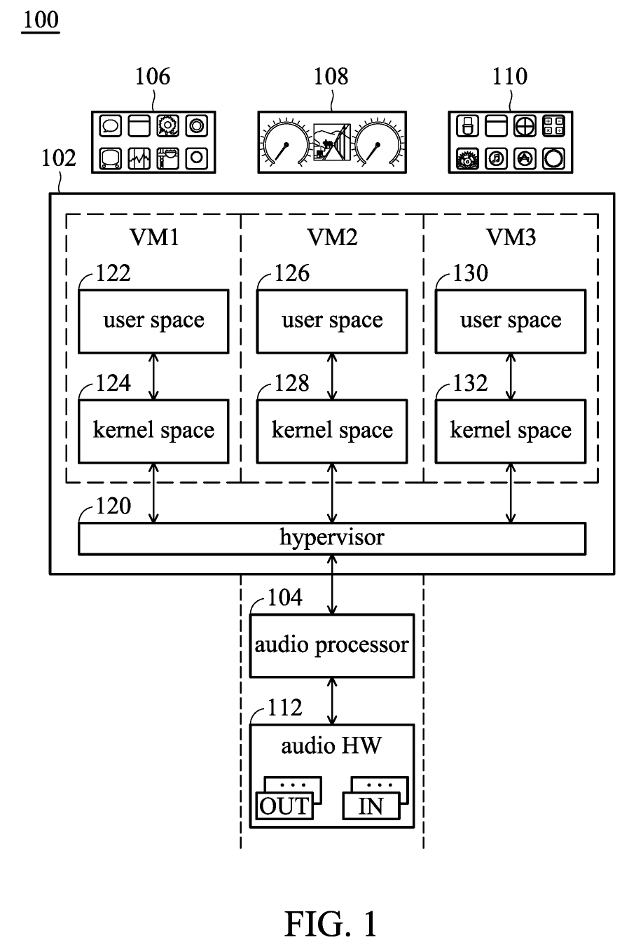

FIG. 1 shows a schematic diagram of a system-on-chip (SoC) 100 in accordance with some embodiments of the present invention. As shown in FIG. 1, the SoC 100 includes a system processor 102, an audio processor 104, and audio hardware (HW) 112. The system processor 102 is electrically connected to the audio processor 104. The audio processor 104 is electrically connected to the audio hardware 112. In some embodiments, the system processor 102 executes a hypervisor 120 to virtualize multiple virtual machines (VMs), such as a virtual machine VM1, a virtual machine VM2, and a virtual machine VM3. The VMs output audio data and control data from multiple vehicle-mount devices. For example, the virtual machine VM1 outputs audio data and control data from a vehicle-mount device 106. The virtual machine VM2 outputs audio data and control data from a vehicle-mount device 108. The virtual machine VM3 outputs audio data and control data from a vehicle-mount device 110.

In some embodiments, the audio processor 104 receives the audio data and the control data from the system processor 102, establishes multiple tasks based on the audio data and the control data from the virtual machines VM1, VM2, and VM3, performs mixing and audio processing on the audio data task-by-task to generate processed audio data, and outputs the processed audio data to the audio hardware 112. For example, the audio processor 104 performs mixing and audio processing (such as volume control, media sound effects, format conversion) on the audio data based on application requirement in each of the tasks. In detail, each VM includes a user space and a kernel space. For example, the virtual machine VM1 includes a user space 122 and a kernel space 124. The virtual machine VM2 includes a user space 126 and a kernel space 128. The virtual machine VM3 includes a user space 130 and a kernel space 132. In some embodiments of FIG. 1, the virtual machine VM2 is a host virtual machine, and the virtual machines VM1 and VM3 are guest virtual machines, but the present invention is not limited thereto.

In some embodiments, the vehicle-mount devices 106 and 110 may be T-boxes, and the vehicle-mount device 108 may be a dashboard, but the present invention is not limited thereto. For example, when a user touches the display of the vehicle-mount device 106 to select an application for playing music in the vehicle, the user space 122 of the virtual machine VM1 obtains the audio data and the control data from the vehicle-mount device 106. Then, the user space 122 sends the audio data and the control data from the vehicle-mount device 106 to the kernel space 124 of the virtual machine VM1. Since the virtual machine VM1 is the guest virtual machine, the kernel space 124 of the virtual machine VM1 may send the audio data and the control data from the vehicle-mount device 106 to the user space 126 of the virtual machine VM2, so that the audio processor 104 and the audio hardware 112 can be driven by the kernel space 128 of the virtual machine VM2 (that is, the host VM) based on the audio data and the control data from the vehicle-mount device 106.

For example, when the speed of the vehicle exceeds the speed limit, the user space 126 of the virtual machine VM2 obtains the audio data and the control data from the vehicle-mount device 108 for alert sound. Then, the user space 126 sends the audio data and the control data from the vehicle-mount device 108 to the kernel space 128 of the virtual machine VM2. Since the virtual machine VM2 is the host virtual machine, the audio hardware 112 can be driven by the kernel space 128 of the virtual machine VM2 based on the audio data and the control data from the vehicle-mount device 108. In some embodiments, the audio hardware 112 may plays the music from the vehicle-mount device 106 and the alert sound from the vehicle-mount device 108 at the same time or in sequence. In some embodiments of FIG. 1, the audio hardware 112 includes multiple input ports IN and multiple output ports OUT. The audio hardware 112 may play the music and the alert sound through the output ports OUT.

In some embodiments, when the user enables the function of speech recognition from the vehicle-mount device 110, the user space 130 of the virtual machine VM3 obtains the control data from the vehicle-mount device 110 for speech recognition. Then, the user space 130 sends the control data from the vehicle-mount device 110 to the kernel space 132 of the virtual machine VM3. Since the virtual machine VM3 is the guest virtual machine, the kernel space 132 of the virtual machine VM3 may send the control data from the vehicle-mount device 110 to the user space 126 of the virtual machine VM2, so that the input ports IN (for example, a microphone) of the audio hardware 112 can be driven by the kernel space 128 of the virtual machine VM2 (that is, the host VM) based on the control data from the vehicle-mount device 110.

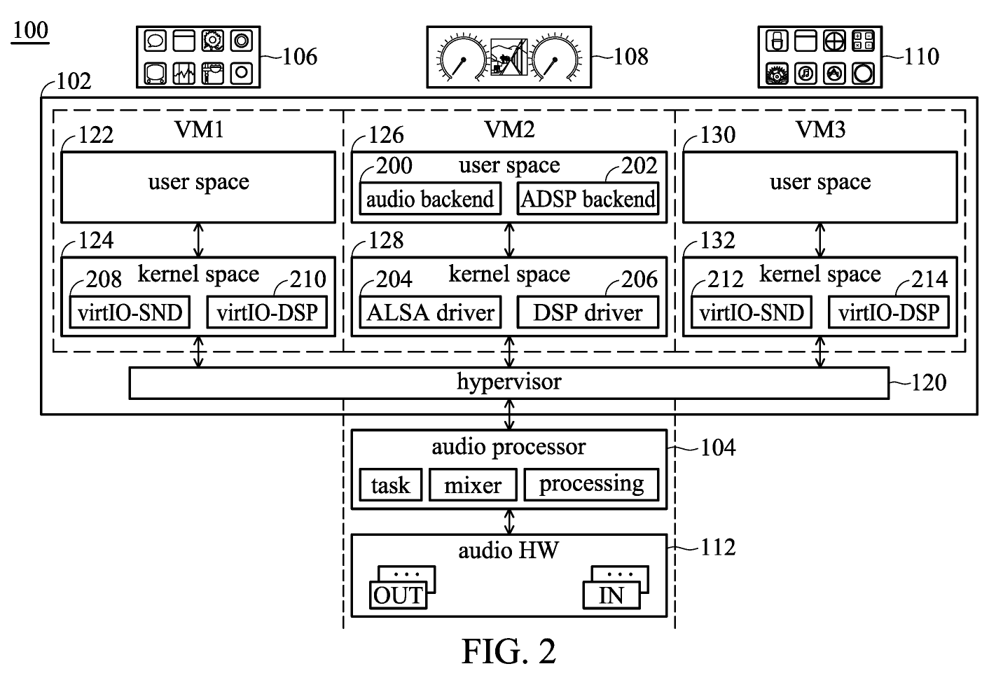

FIG. 2 shows a detail schematic diagram of the SoC 100 in FIG. 1 in accordance with some embodiments of the present invention. As shown in FIG. 2, the SoC 100 includes the system processor 102, the audio processor 104, and the audio hardware 112. The system processor 102 is electrically connected to the audio processor 104. The audio processor 104 is electrically connected to the audio hardware 112. In some embodiments, the system processor 102 executes the hypervisor 120 to virtualize the virtual machine VM1, the virtual machine VM2, and the virtual machine VM3.The virtual machine VM1 outputs audio data and control data from the vehicle-mount device 106. The virtual machine VM2 outputs audio data and control data from the vehicle-mount device 108. The virtual machine VM3 outputs audio data and control data from the vehicle-mount device 110.

In some embodiments, the audio processor 104 receives the audio data and the control data from the system processor 102, establishes multiple tasks based on the audio data and the control data from the virtual machines VM1, VM2, and VM3 (for example the task function in the audio processor 104 in FIG. 2), performs mixing and audio processing on the audio data task-by-task to generate processed audio data (for example, the mixer function and the processing function in the audio processor 104 in FIG. 2), and outputs the processed audio data to the audio hardware 112. In detail, the virtual machine VM1 includes the user space 122 and the kernel space 124. The virtual machine VM2 includes the user space 126 and the kernel space 128. The virtual machine VM3 includes the user space 130 and the kernel space 132. In some embodiments of FIG. 2, the virtual machine VM2 is the host virtual machine, and the virtual machines VM1 and VM3 are the guest virtual machines, but the present invention is not limited thereto.

In some embodiments, since the virtual machines VM1 and VM3 are the guest virtual machines, the hypervisor 120 virtualizes an audio input/output (I/O) port (virtIO-SND) 208 and a digital signal processing (DSP) I/O port (virtIO-DSP) 210 in the kernel space 124 of the virtual machine VM1. The hypervisor 120 virtualizes an audio I/O port 212 and a DSP I/O port 214 in the kernel space 132 of the virtual machine VM3. In some embodiments, since the virtual machine VM2 is the host virtual machine, the hypervisor 120 establishes an audio backend 200 and an audio digital signal processing (ADSP) backend 202 in the user space 126 of the virtual machine VM2. The hypervisor 120 establishes an audio driver 204 and a DSP driver 206 in the kernel space 128 of the virtual machine VM2. In some embodiments, the audio driver 204 may be an Advanced Linux Sound Architecture (ALSA) driver, but the present invention is not limited thereto. The audio driver 204 drives the audio hardware 112 based on the audio data from the vehicle-mount devices 106, 108 and 110. The DSP driver 206 sends the control data from the vehicle-mount devices 106, 108 and 110 to the audio processor 104 to control the audio hardware 112.

For example, in some embodiments of FIG. 2, the virtual machine VM1 sends the audio data to the virtual machine VM2 through the virtualized audio I/O port 208 in the kernel space 124. The virtual machine VM2 receives the audio data from the virtual machine VM1 through the audio backend 200 in the user space 126. Similarly, the virtual machine VM3 sends the audio data to the virtual machine VM2 through the virtualized audio I/O port 212 in the kernel space 132. The virtual machine VM2 receives the audio data from the virtual machine VM3 through the audio backend 200 in the user space 126.

For example, in some embodiments of FIG. 2, the virtual machine VM1 sends the control data to the virtual machine VM2 through the virtualized DSP I/O port 210 in the kernel space 124. The virtual machine VM2 receives the control data from the virtual machine VM1 through the ADSP backend 202 in the user space 126. Similarly, the virtual machine VM3 sends the control data to the virtual machine VM2 through the virtualized DSP I/O port 214 in the kernel space 132. The virtual machine VM2 receives the control data from the virtual machine VM3 through the ADSP backend 202 in the user space 126.

When the user touches the display of the vehicle-mount device 106 to select an application for playing music in the vehicle, the user space 122 of the virtual machine VM1 obtains the audio data and the control data from the vehicle-mount device 106. Then, the user space 122 sends the audio data and the control data from the vehicle-mount device 106 to the kernel space 124 of the virtual machine VM1. Since the virtual machine VM1 is the guest virtual machine, the kernel space 124 of the virtual machine VM1 may send the audio data from the vehicle-mount device 106 to the user space 126 of the virtual machine VM2 through the virtualized audio I/O port 208. The kernel space 124 of the virtual machine VM1 may send the control data from the vehicle-mount device 106 to the user space 126 of the virtual machine VM2 through the virtualized DSP I/O port 210. Therefore, the audio hardware 112 can be driven by the audio driver 204 in the kernel space 128 of the virtual machine VM2 (that is, the host VM) based on the audio data from the vehicle-mount device 106. Similarly, the audio hardware 112 can be driven by the DSP driver 206 in the kernel space 128 of the virtual machine VM2 (that is, the host VM) based on the control data from the vehicle-mount device 106.

When the speed of the vehicle exceeds the speed limit, the user space 126 of the virtual machine VM2 obtains the audio data from the vehicle-mount device 108 for alert sound through the audio backend 200. The user space 126 of the virtual machine VM2 obtains the control data from the vehicle-mount device 108 for alert sound through the ADSP backend 202. Then, the user space 126 sends the audio data and the control data from the vehicle-mount device 108 to the kernel space 128 of the virtual machine VM2. Since the virtual machine VM2 is the host virtual machine, the audio hardware 112 can be driven by the audio driver 204 in the kernel space 128 of the virtual machine VM2 based on the audio data. Similarly, the audio hardware 112 can be driven by the DSP driver 206 in the kernel space 128 of the virtual machine VM2 based on the control data from the vehicle-mount device 108.

When the user enables the function of speech recognition from the vehicle-mount device 110, the user space 130 of the virtual machine VM3 obtains the control data from the vehicle-mount device 110 for speech recognition. Then, the user space 130 sends the control data from the vehicle-mount device 110 to the kernel space 132 of the virtual machine VM3. Since the virtual machine VM3 is the guest virtual machine, the virtualized DSP I/O port 214 in the kernel space 132 of the virtual machine VM3 may send the control data from the vehicle-mount device 110 to the ADSP backend 202 in the user space 126 of the virtual machine VM2, so that the input ports IN (for example, the microphone) of the audio hardware 112 can be driven by the DSP driver 206 in the kernel space 128 of the virtual machine VM2 (that is, the host VM) based on the control data from the vehicle-mount device 110.

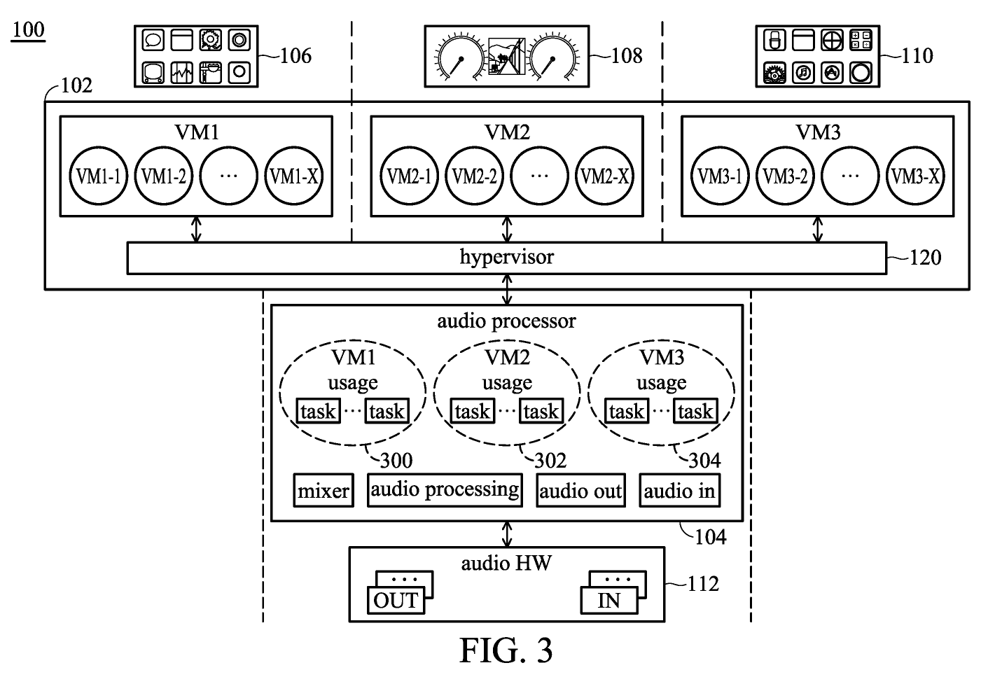

FIG. 3 shows a detail schematic diagram of the SoC 100 in FIG. 1 in accordance with some embodiments of the present invention. As shown in FIG. 3, the SoC 100 includes the system processor 102, the audio processor 104, and the audio hardware 112. The system processor 102 is electrically connected to the audio processor 104. The audio processor 104 is electrically connected to the audio hardware 112. In some embodiments, the system processor 102 executes the hypervisor 120 to virtualize the virtual machine VM1, the virtual machine VM2, and the virtual machine VM3.The virtual machine VM1 outputs audio data and control data from the vehicle-mount device 106. The virtual machine VM2 outputs audio data and control data from the vehicle-mount device 108. The virtual machine VM3 outputs audio data and control data from the vehicle-mount device 110.

In some embodiments, the audio processor 104 receives the audio data and the control data from the system processor 102, establishes multiple tasks based on the audio data and the control data from the virtual machines VM1, VM2, and VM3 (for example the task function in the audio processor 104 in FIG. 3), performs mixing and audio processing on the audio data task-by-task to generate processed audio data (for example, the mixer function and the processing function in the audio processor 104 in FIG. 3), and outputs the processed audio data to the audio hardware 112. In some embodiments of FIG. 3, the virtual machine VM2 is the host virtual machine, and the virtual machines VM1 and VM3 are the guest virtual machines, but the present invention is not limited thereto.

In detail, the virtual machine VM1 generates multiple audio application scenarios, such as audio application scenarios VM1-1, VM1-2,..., VM1-X, based on the audio data and the control data from the vehicle-mount device 106. The virtual machine VM2 generates multiple audio application scenarios, such as audio application scenarios VM2-1, VM2-2,..., VM2-X, based on the audio data and the control data from the vehicle-mount device 108. Similarly, the virtual machine VM3 generates multiple audio application scenarios, such as audio application scenarios VM3-1, VM3-2,..., VM3-X, based on the audio data and the control data from the vehicle-mount device 110. After that, the audio processor 104 establishes a task group 300 for virtual machine VM1 usage based on the audio data and the control data (for example, based on the audio application scenarios VM1-1, VM1-2,..., VM1-X) from the virtual machine VM1. The audio processor 104 establishes a task group 302 for virtual machine VM2 usage based on the audio data and the control data (for example, based on the audio application scenarios VM2-1, VM2-2,..., VM2-X) from the virtual machine VM2. The audio processor 104 establishes a task group 304 for virtual machine VM3 usage based on the audio data and the control data (for example, based on the audio application scenarios VM3-1, VM3-2,..., VM3-X) from the virtual machine VM3.

Each task in the task group 300 may correspond to one of the audio application scenarios VM1-1, VM1-2,..., VM1-X. For example, when the user touches the display of the vehicle-mount device 106 to select the application for playing music in the vehicle, the virtual machine VM1 generates the audio application scenario VM1-1. Next, the audio processor 104 establishes a task in the task group 300 to process the audio application scenario VM1-1.

Each task in the task group 302 may correspond to one of the audio application scenarios VM2-1, VM2-2,..., VM2-X. For example, when the speed of the vehicle exceeds the speed limit, the virtual machine VM2 generates the audio application scenario VM2-1. Next, the audio processor 104 establishes a task in the task group 302 to process the audio application scenario VM2-1.

Each task in the task group 304 may correspond to one of the audio application scenarios VM3-1, VM3-2,..., VM3-X. For example, when the user enables the function of speech recognition from the vehicle-mount device 110, the virtual machine VM3 generates the audio application scenario VM3-1. Next, the audio processor 104 establishes a task in the task group 304 to process the audio application scenario VM3-1. The audio processor 104 performs mixing and audio processing on the audio data task-by-task to generate processed audio data. That is, the audio processor 104 performs mixing and audio processing on the audio data based on application requirement in each of the tasks. After that, the audio processor 104 outputs the processed audio data to the audio hardware 112 through an audio out port. In some embodiments, the audio processor 104 receives the audio data from the audio hardware 112 (for example, the microphone) through an audio in port.

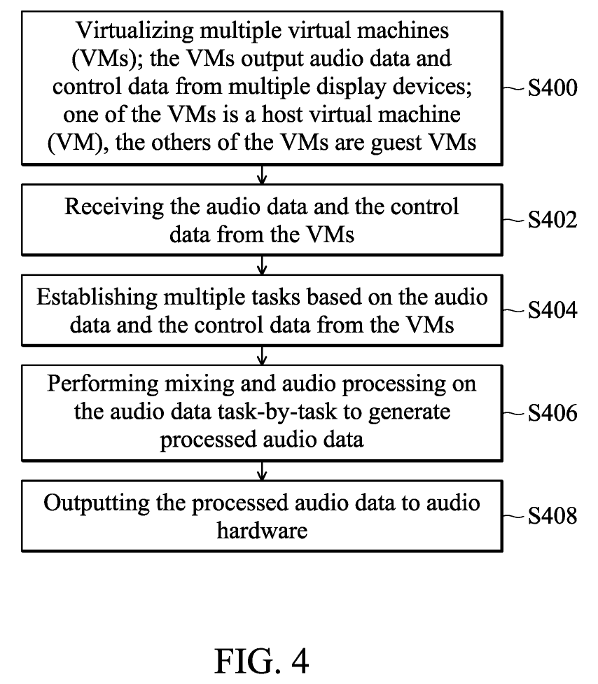

FIG. 4 show a flow chart of a method for multi-domain audio management in accordance with some embodiments of the present invention. The method for multi-domain audio management is applied to the SoC 100 in FIGS. 1-3. The method for multi-domain audio management includes the following steps. Multiple virtual machines (VMs) are virtualized (step S400). The VMs output audio data and control data from multiple vehicle-mount devices. One of the VMs is a host virtual machine (VM), and the other VMs are guest VMs. The audio data and the control data from the VMs are received (step S402). Multiple tasks are established based on the audio data and the control data from the VMs (step S404). Mixing and audio processing are performed on the audio data task-by-task to generate processed audio data (step S406). The processed audio data are output to audio hardware (step S408). In some embodiments, steps S400 and S402 are executed by a hypervisor (for example, the hypervisor 120) executed by a system processor (for example, the system processor 102) in the SoC 100. Steps S404, S406, and S408 are executed by an audio processor (for example, the audio processor 104) in the SoC 100.

In some embodiments, in step S400, each VM includes a user space and a kernel space. The audio data and the control data from vehicle-mount devices correspond to different audio application scenarios. The method for multi-domain audio management further includes the following steps. An audio input/output (I/O) port and a digital signal processing (DSP) I/O port in the kernel space of each guest VM are virtualized by the hypervisor. An audio backend and an audio digital signal processing (ADSP) backend in the user space of the host VM are established by the hypervisor. An audio driver and a DSP driver in the kernel space of the host VM are established by the hypervisor. The audio driver drives the audio hardware based on the audio data from the vehicle-mount devices. The DSP driver sends the control data from the vehicle-mount devices to the audio processor to control the audio hardware.

In some embodiments, the method for multi-domain audio management further includes the following steps. Each guest VM sends the audio data to the host VM through the virtualized audio I/O port in the kernel space of each guest VM. The host VM receives the audio data from each guest VM through the audio backend in the user space of the host VM. In some embodiments, each guest VM sends the audio data to the host VM through the virtualized audio I/O port in the kernel space of each guest VM. The host VM receives the control data from each guest VM through the ADSP backend in the user space of the host VM.

The SoC 100 in FIGS. 1-3 and the method for multi-domain audio management of the present invention uses a built-in ADSP to complete the audio processing and mixing of multi-domain audio data within a single main control SoC, and the audio data of the same application scenario is mixed in advance, saving the need for audio I/O.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system-on-chip (SoC), comprising:
a system processor, configured to execute a hypervisor to virtualize multiple virtual machines (VMs); wherein the VMs output audio data and control data from multiple vehicle-mount devices; wherein one of the VMs is a host virtual machine (VM), and the other VMs are guest VMs;
an audio processor, electrically connected to the system processor, configured to receive the audio data and the control data from the system processor, establish multiple tasks based on the audio data and the control data from the VMs, perform mixing and audio processing on the audio data task-by-task to generate processed audio data, and output the processed audio data to audio hardware.

2. The SoC as claimed in claim 1, wherein each VM comprises a user space and a kernel space.

3. The SoC as claimed in claim 2, wherein the hypervisor virtualizes audio input/output (I/O) ports and digital signal processing (DSP) I/O ports in the kernel space of each guest VM.

4. The SoC as claimed in claim 3, wherein the hypervisor establishes an audio backend and an audio digital signal processing (ADSP) backend in the user space of the host VM.

5. The SoC as claimed in claim 3, wherein each guest VM sends the audio data to the host VM through the virtualized audio I/O port in the kernel space; and the host VM receives the audio data from each guest VM through the audio backend in the user space.

6. The SoC as claimed in claim 3, wherein each guest VM sends the control data to the host VM through the virtualized DSP I/O port in the kernel space; and the host VM receives the control data from each guest VM through the ADSP backend in the user space.

7. The SoC as claimed in claim 3, wherein the hypervisor establishes an audio driver and a DSP driver in the kernel space of the host VM; the audio driver drives the audio hardware based on the audio data from the vehicle-mount devices; and the DSP driver sends the control data from the vehicle-mount devices to the audio processor to control the audio hardware.

8. The SoC as claimed in claim 1, wherein the VMs comprise a first VM, a second VM, and a third VM; the vehicle-mount devices comprise a first vehicle-mount device, a second vehicle-mount device, and a third vehicle-mount device; the first VM outputs audio data and control data from the first vehicle-mount device, the second VM outputs audio data and control data from the second vehicle-mount device, and the third VM outputs audio data and control data from the third vehicle-mount device.

9. The SoC as claimed in claim 8, wherein the audio processor is configured to:
establish a first task group based on the audio data and the control data from the first VM;
establish a second task group based on the audio data and the control data from the second VM; and
establish a third task group based on the audio data and the control data from the third VM.

10. The SoC as claimed in claim 9, wherein the first task group comprises tasks corresponding to the first VM; the second task group comprises tasks corresponding to the second VM; and the third task group comprises tasks corresponding to the third VM.

11. The SoC as claimed in claim 1, wherein the audio data and the control data from vehicle-mount devices correspond to different audio application scenarios.

12. The SoC as claimed in claim 1, wherein the audio processor performs mixing and audio processing on the audio data based on application requirement in each of the tasks.

13. A method for multi-domain audio management, applied to a system processor and an audio processor, comprising:
virtualizing multiple virtual machines (VMs); wherein the VMs output audio data and control data from multiple vehicle-mount devices; wherein one of the VMs is a host virtual machine (VM), and the other VMs are guest VMs;
receiving the audio data and the control data from the VMs;
establishing multiple tasks based on the audio data and the control data from the VMs;
performing mixing and audio processing on the audio data task-by-task to generate processed audio data, and
outputting the processed audio data to audio hardware.

14. The method for multi-domain audio management as claimed in claim 13, wherein each VM comprises a user space and a kernel space.

15. The method for multi-domain audio management as claimed in claim 14, further comprising:
virtualizing audio input/output (I/O) ports and digital signal processing (DSP) I/O ports in the kernel space of each guest VM.

16. The method for multi-domain audio management as claimed in claim 15, further comprising:
establishing an audio backend and an audio digital signal processing (ADSP) backend in the user space of the host VM.

17. The method for multi-domain audio management as claimed in claim 15, further comprising:
each guest VM sending the audio data to the host VM through the virtualized audio I/O port in the kernel space; and
the host VM receiving the audio data from each guest VM through the audio backend in the user space.

18. The method for multi-domain audio management as claimed in claim 15, further comprising:
each guest VM sending the control data to the host VM through the virtualized audio I/O port in the kernel space; and
the host VM receiving the control data from each guest VM through the ADSP backend in the user space.

19. The method for multi-domain audio management as claimed in claim 15, further comprising:
establishing an audio driver and a DSP driver in the kernel space of the host VM;
wherein the audio driver drives the audio hardware based on the audio data from the vehicle-mount devices; and the DSP driver sends the control data from the vehicle-mount devices to the audio processor to control the audio hardware.

20. The method for multi-domain audio management as claimed in claim 13, wherein the audio data and the control data from vehicle-mount devices correspond to different audio application scenarios.

21. The method for multi-domain audio management as claimed in claim 13, wherein the step of performing mixing and audio processing on the audio data task-by-task comprises:
performing mixing and audio processing on the audio data based on application requirement in each of the tasks.
